(19) United States
(12) Patent Application Publication
(10) Pub. No.: US 2006/0208542 A1
(43) Pub. Date: Sep. 21, 2006

(54) Motorcycle seat

(76) Inventor: Damian R. Baker, Stevenson Ranch, CA (US)

Correspondence Address: LITMAN LAW OFFICES, LTD, PO BOX 15035, CRYSTAL CITY STATION, ARLINGTON, VA, 22215, US

(21) Appl. No.: 11/080,820

(22) Filed: Mar. 16, 2005

(51) Int. Cl. B62J 1/00

(52) U.S. Cl. 297/195.12

(57) ABSTRACT

The off-road and dirt motorcycle seat is adapted to support a motorcycle rider's body in a forward leaning position on the seat for motorcycle racing. The anterior portion of the elongated seat is recessed to form a cradle. The cradle helps the rider maintain a forward leaning position while riding at high speeds. The cradle has a smaller radius of curvature in the rear portion of the cradle, to provide a steep grade upon which the rider may be supported. A larger radius of curvature in the front portion of the cradle allows the rider to lean forward properly in the cradle.

### BACKGROUND OF THE INVENTION

1. Field of the Invention

The present invention relates to motorcycle saddles. More specifically, the invention is a high-performance saddle for motocross and other off-road sport motorcycles that provides the user with greater control of the cycle during high-speed racing.

2. Description of the Related Art

Off-road and dirt motorcycle racing is a fast growing sport in this country and around the world. Through intense competition, the motorcycles, the riders and the riders' equipment have all been studied and refined in order to increase performance. With these studies, the industry has seen that a rider that can stay as far forward on the cycle as possible during the race can achieve an increase in control, safety and speed.

Off-road and dirt motorcycle racing seats have thus been designed to allow the rider to slide forward during the race. The seats are angled slightly forward and tapered toward the front. However, due to the forces acting on the rider during a high-speed race, it becomes increasingly difficult for the rider to remain in position the further forward he or she attempts to move.

The rider will benefit from being able to remain in the optimum forward seated position during a race, without compromising the rider's comfort, or ability to handle and maneuver the motorcycle. Thus, a motorcycle seat solving the aforementioned problems is desired.

### SUMMARY OF THE INVENTION

The off-road and dirt motorcycle seat is adapted to support a motorcycle rider's body in a forward leaning position on the seat for motorcycle racing. The motorcycle seat has an elongated body with an anterior portion and a planar posterior portion. The anterior portion of the elongated seat is recessed to form a cradle.

The cradle helps the rider maintain a forward leaning position while riding at high speeds. This position helps the rider handle the motorcycle by offering a more centralized and lower center of gravity. The cradle also helps reduce rider fatigue by reducing the effort the rider must make in order to stay in that forward leaning position throughout a race. The cradle has a front portion and a rear portion. The cradle has a smaller radius of curvature in the rear portion, to provide a steep grade upon which the rider may be supported. A larger radius of curvature in the front portion of the cradle allows the rider to lean forward properly in the cradle.

The anterior portion of the seat may taper slightly from the rear portion of the cradle to the front portion of the cradle. This slight taper also helps the rider maintain a forward leaning position when racing. The dimensions of the anterior portion of the motorcycle seat depend on the make and model of motorcycle and the size and preferences of the rider.

A traditional off-road and dirt motorcycle seat design is generally comprised of a hard plastic base, a molded padding, a seat cover, and a means for attaching the seat to the motorcycle. The base provides structural support to the seat, and helps stabilize the seat on the motorcycle. The base is generally injection molded to produce a design that fits flush against the body of the motorcycle, or that may be mounted to the motorcycle in some other typical manner. The base includes a means for attaching the seat to the motorcycle. This means for attaching the seat is well known in the art.

The padding provides comfort to the rider, and also provides the shape of the seat. The cradle in the anterior portion of the seat may be formed in the padding portion of the assembly. The padding is secured to the base. The padding may vary in degree of firmness, depending on the make and model of the motorcycle and the preferences of the user. The materials used in the padding to provide the varying levels of firmness are well known in the art.

The seat cover conforms to the shape and contours of the padding, and is used to protect the padding from wear and to provide an aesthetically appealing look to the motorcycle seat. The means for securing the seat cover to the padding and the base are well known in the art.

These and other features of the present invention will become readily apparent upon further review of the following specification and drawings.

### BRIEF DESCRIPTION OF THE DRAWINGS

FIG. 1 is an environmental perspective view of a motorcycle seat as installed on a motorcycle according to the present invention.

FIG. 2 is a side view of a motorcycle seat according to the present invention.

FIG. 3 is a top view of a motorcycle seat according to the present invention.

FIG. 4 is an exploded, perspective view of a motorcycle seat assembly according to the present invention.

Similar reference characters denote corresponding features consistently throughout the attached drawings.

### DETAILED DESCRIPTION OF THE PREFERRED EMBODIMENTS

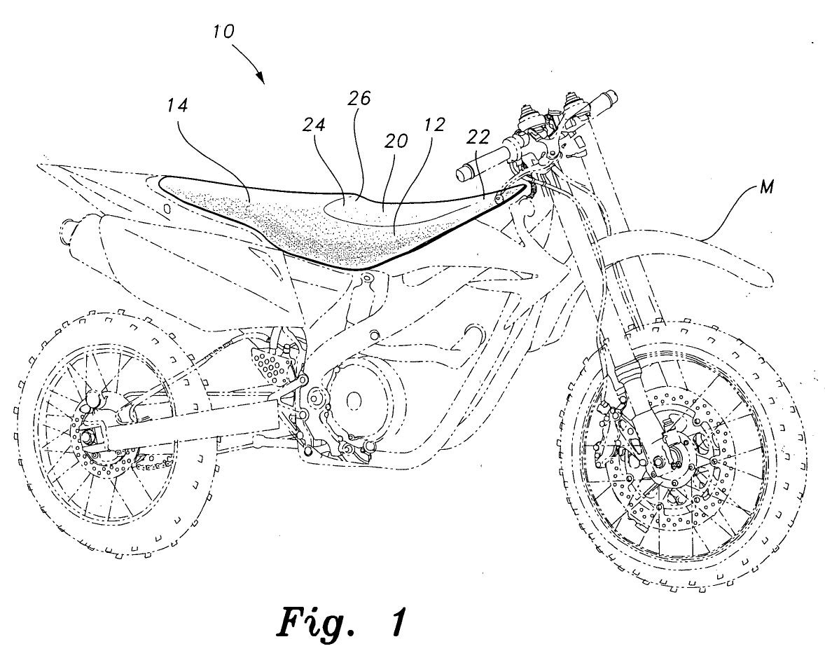

The present invention is a motorcycle seat that is adapted to support a motorcycle rider's body in a forward leaning position on the seat for motorcycle racing. The motorcycle seat is designated in the Figures generally as 10. As can be seen in FIG. 1, the motorcycle seat 10 has an elongated body with an anterior portion 12 and a planar posterior portion 14. The anterior portion 12 of the elongated seat 10 is recessed to form a cradle 20.

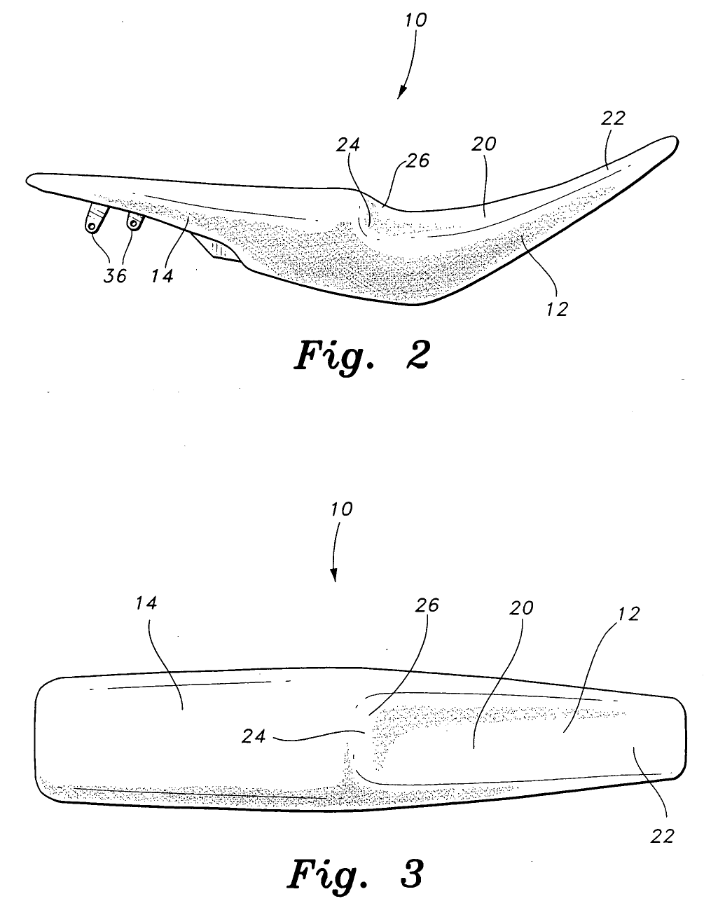

The cradle 20 helps the rider maintain a forward leaning position while riding at high speeds. This position helps the rider handle the motorcycle M by offering a more centralized and lower center of gravity. The cradle 20 also helps reduce rider fatigue by reducing the effort the rider must make in order to stay in that forward leaning position throughout a race. As can be seen in FIG. 2, the cradle 20 has a front portion 22 and a rear portion 24. The cradle 20 has a smaller radius of curvature in the rear portion 24, to provide a steep grade 26 upon which the rider may be supported. A larger radius of curvature in the front portion 22 of the cradle 20 allows the rider to lean forward properly in the cradle 20.

The anterior portion 12 of the seat 10 may taper slightly from the rear portion 24 of the cradle 20 to the front portion 22 of the cradle 20, as shown in FIG. 3. This slight taper also helps the rider maintain a forward leaning position when racing. The dimensions of the anterior portion 12 of the motorcycle seat 10 depend on the make and model of motorcycle M and the size and preferences of the rider.

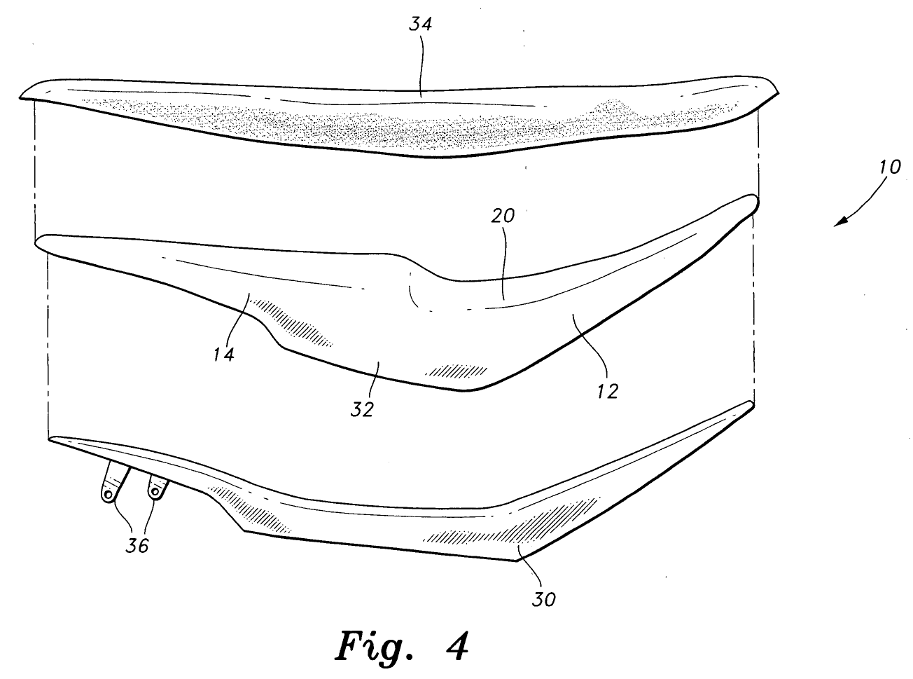

A traditional motorcycle seat design is generally comprised of a hard plastic base 30, a molded padding 32, a seat cover 34, and a means 36 for attaching the seat 10 to the motorcycle M, as shown in FIG. 4. The base 30 provides structural support to the seat 10, and helps stabilize the seat 10 on the motorcycle M. The base 30 is generally injection molded to produce a design that fits flush against the body of the motorcycle M, or that may be mounted to the motorcycle M in some other typical manner. The base 30 includes a means 36 for attaching the seat 10 to the motorcycle M. This means 36 for attaching the seat 10 is well known in the art.

The padding 32 provides comfort to the rider, and also provides the shape of the seat 10. The cradle 20 in the anterior portion 12 of the seat 10 may be formed in the padding 32 portion of the assembly. The padding 32 is secured to the base 30 by a means known in the art. The padding 32 may vary in degree of firmness, depending on the make and model of the motorcycle M and the preferences of the user. The materials used in the padding 32 to provide the varying levels of firmness are well known in the art.

The seat cover 34 conforms to the shape and contours of the padding 32, and is used to protect the padding 32 from wear and to provide an aesthetically appealing look to the motorcycle seat 10. The means for securing the seat cover 34 to the padding 32 and the base 30 are well known in the art.

It is to be understood that the present invention is not limited to the embodiments described above, but encompasses any and all embodiments within the scope of the following claims.

I claim:

1. A motorcycle seat, comprising an elongated body having a recessed anterior portion and a planar posterior portion, the recessed anterior portion defining a steep grade leading up to the posterior portion, the grade being adapted for supporting a motorcycle rider's body in a forward leaning position on the anterior portion for motorcycle racing.

2. The motorcycle seat according to claim 1, wherein said anterior portion further comprises a forward portion having a predetermined large radius of curvature and a rear portion having a predetermined small radius of curvature, said small radius of curvature defining said steep grade.

3. The motorcycle seat according to claim 1, further comprising a base having a means for securing said motorcycle seat to a motorcycle body.

4. The motorcycle seat according to claim 1, further comprising said anterior portion having a length between 11 inches and 15 inches, such that said motorcycle seat rests properly flush on the motorcycle body.

5. The motorcycle seat according to claim 1, further comprising said anterior portion having a depth between 0.5 inches and 1.5 inches, such that a rider supported on said anterior portion may be seated properly on said motorcycle seat.

6. A motorcycle seat, comprising an elongated body having a cradle and a plateau, the cradle having a forward portion having a large radius of curvature and a rear portion having a small radius of curvature leading up to the plateau, the rear portion being adapted for supporting a motorcycle rider's body in a forward leaning position on the cradle for motorcycle racing.

7. The motorcycle seat according to claim 6, further comprising a base having a means for securing said motorcycle seat to the motorcycle body.

8. The motorcycle seat according to claim 1, further comprising said cradle having a length between 11 inches and 15 inches, such that said motorcycle seat rests properly flush on the motorcycle body.

9. The motorcycle seat according to claim 1, further comprising said cradle having a depth between 0.5 inches and 1.5 inches, such that a rider supported on said cradle may be seated properly on said motorcycle seat.
